(19) United States
(12) Patent Application Publication
(10) Pub. No.: US 2020/0070851 A1
(43) Pub. Date: Mar. 5, 2020

(54) VEHICLE CONTROL APPARATUS

(71) Applicant: TOYOTA JIDOSHA KABUSHIKI KAISHA, Toyota-shi (JP)

(72) Inventors: Shunya KATO, Seto-shi (JP); Yasutaka TSUCHIDA, Toyota-shi (JP); Kazuhiro IKETOMI, Nagoya-shi (JP)

(73) Assignee: TOYOTA JIDOSHA KABUSHIKI KAISHA, Toyota-shi (JP)

(21) Appl. No.: 16/555,324

(22) Filed: Aug. 29, 2019

(30) Foreign Application Priority Data
Aug. 29, 2018 (JP) 2018-160783

(51) Int. Cl. B60W 50/12; B60W 20/40; F01N 3/021; F16H 59/04; B60W 20/16

(52) U.S. Cl. CPC B60W 50/12; B60W 20/40; F16H 2059/0282; F16H 59/04; B60W 20/16; F01N 3/021

(57) ABSTRACT

A control apparatus for a vehicle provided with an engine having a filter for removing particulate substances from an exhaust emission, drive wheels, and an automatic transmission, includes: a shift control portion configured to control a speed ratio of the automatic transmission; a drive power source control portion configured to control an output of the engine on the basis of the operator-required vehicle drive force; an engine output limiting portion configured to limit the output of the engine, preferentially to an output control of the engine by the drive power source control portion, while the filter is plugged with the particulate substances accumulated therein; and an upper limit setting portion configured to set an upper limit of the operator-required vehicle drive force used by the shift control portion, on the basis of limitation of the output of the engine by the engine output limiting portion.

This application claims priority from Japanese Patent Application No. 2018-160783 filed on Aug. 29, 2018, the disclosure of which is incorporated herein by reference in its entirety.

### FIELD OF THE INVENTION

The present invention relates in general to a vehicle control apparatus, and more particularly to a control apparatus for a vehicle provided with an engine having a filter for separating or removing particulate substances from an exhaust emission from the engine.

### BACKGROUND OF THE INVENTION

There is known a control apparatus for a vehicle provided with an engine, drive wheels, and an automatic transmission constituting a part of a power transmitting path between the engine and the drive wheels. The control apparatus includes a shift control portion to control a speed ratio of the automatic transmission on the basis of a running speed of the vehicle, and a required vehicle drive force as represented by an operation amount of an accelerator pedal, and a drive power source control portion to control an output of the engine on the basis of the required vehicle drive force. JP2017-194103A discloses an example of this type of control apparatus. On the other hand, there is known an engine which is provided with a filter to separate particular substances such as PM (particulate matters) from its exhaust emission. JP2016-183575A, JP2017-141791A and JP2017-66992A disclose examples of this type of engine. Plugging of the filter with the particular substances accumulated therein disturbs a flow of the exhaust emission. To solve this problem, it has been considered to limit the output of the engine, or to control the engine so as to facilitate burning of the accumulated particular substances, for thereby automatically recover the filter.

However, the automatic recovery of the filter as well as the limitation of the output of the engine causes a deviation of an actual value of the engine output from a value of the engine output expected according to the required vehicle drive force. This deviation prevents an adequate shift control of the automatic transmission on the basis of the required vehicle drive force used as a control parameter, and may cause generation of a shifting shock of the automatic transmission, an increase of a required shifting time, and any other deterioration of shifting performance of the automatic transmission.

### SUMMARY OF THE INVENTION

The present invention was made in view of the background art described above. It is therefore an object of the present invention to provide a control apparatus for a vehicle provided with an automatic transmission and an engine having a filter, which control apparatus permits an adequate shift control of the automatic transmission on the basis of a required vehicle drive force used as a control parameter, irrespective of limitation of an output of the engine due to plugging of the filter.

The object indicated above is achieved according to the following modes of the present invention:

According to a first mode of the invention, there is provided a control apparatus for a vehicle provided with an engine having a filter for removing particulate substances from an exhaust emission, drive wheels, and an automatic transmission constituting a part of a power transmitting path between the engine and the drive wheels, the control apparatus comprising: a shift control portion configured to control a speed ratio of the automatic transmission on the basis of an operator-required vehicle drive force and a running speed of the vehicle; a drive power source control portion configured to control an output of the engine on the basis of the operator-required vehicle drive force; an engine output limiting portion configured to limit the output of the engine, preferentially to the output control of the engine by the drive power source control portion, while the filter is plugged with the particulate substances accumulated therein; and an upper limit setting portion configured to set an upper limit of the operator-required vehicle drive force used by the shift control portion, on the basis of limitation of the output of the engine by the engine output limiting portion, while the output of the engine is limited by the engine output limiting portion.

The operator-required vehicle drive force may be automatically calculated in an automatic vehicle driving mode in which the vehicle is driven at a target running speed or at a target acceleration value, as well as an amount of operation of an accelerator pedal by an operator of the vehicle. The operator-required vehicle drive force may be replaced by an operator-required vehicle drive torque or power, or an operator-required vehicle output. The running speed of the vehicle used by the shift control portion to control the speed ratio of the automatic transmission may be replaced by an output speed of the automatic transmission, or a rotating speed of any other member which corresponds to the vehicle running speed.

According to a second mode of the invention, the control apparatus according to the first mode of the invention is configured such that the upper limit setting portion gradually increases the upper limit after the limitation of the output of the engine by the engine output limiting portion is terminated.

According to a third mode of the invention, the control apparatus according to the first or second mode of the invention uses an operation amount of an accelerator pedal as the operator-required vehicle drive force.

According to a fourth mode of the invention, the control apparatus according to any one of the first through third modes of the invention is configured such that the engine output limiting portion has a filter recovering function for automatically recovering the filter by controlling the engine so as to facilitate burning of the particulate substances accumulated in the filter, during running of the vehicle, the engine output limiting portion limiting the output of the engine by performing the filter recovering function, or by implementing a control for limiting the output of the engine in addition to performing the filter recovering function.

According to a fifth mode of the invention, the vehicle to be controlled by the control apparatus according to any one of the first through fourth modes of the invention is configured such that the automatic transmission is a transmission device including an electrically controlled continuously-variable transmission portion connected to the engine, a differential motor/generator and an intermediate power transmitting member, and a mechanically operated step-variable transmission portion disposed between the intermediate power transmitting member and the drive wheels. In this vehicle, a rotary motion of the engine is transmitted through the continuously-variable transmission portion to the intermediate power transmitting member such that an operating speed of the engine is continuously changed with a torque control of the differential motor/generator. The step-variable transmission portion has a plurality of frictional coupling devices which are selectively engaged and released to mechanically establish a selected one of a plurality of AT gear positions having respective different values of a ratio of a rotating speed of the intermediate power transmitting member to an output speed of the step-variable transmission portion. According to the present fifth mode of the invention, the shift control portion includes a step-variable shifting control portion configured to shift the step-variable transmission portion to the selected AT gear position on the basis of the operator-required vehicle drive force and the running speed of the vehicle, and an overall speed position shifting control portion configured to control the continuously-variable transmission portion on the basis of the operator-required vehicle drive force and the running speed of the vehicle, for selectively establishing a plurality of overall speed positions of the transmission device which have respective different values of a ratio of the operating speed of the engine to the output speed of the step-variable transmission portion. At least one of the plurality of overall speed positions is available for each of the plurality of AT gear positions, and the overall speed position shifting control portion implements a shifting control of the continuously-variable transmission portion concurrently with a shifting control of the step-variable transmission portion by the step-variable shifting control portion, to shift the transmission device to a selected one of the overall speed positions. The vehicle to be controlled by the present control apparatus is provided with a vehicle driving electric motor which cooperates with the engine to function as a drive power source and which is operatively connected to the intermediate power transmitting member in a power transmittable manner, and the drive power source control portion is configured to control both of the engine and the vehicle driving electric motor on the basis of the operator-required vehicle drive force. Further, the upper limit setting portion is configured to set the upper limit of the operator-required vehicle drive force used commonly by both of the step-variable shifting control portion and the overall speed position shifting control portion, on the basis of an output of the drive power source as a whole including the vehicle driving electric motor, which output is limited as a result of the limitation of the output of the engine by the engine output limiting portion.

As described above, the control apparatus according to the first mode of the invention is configured to set the upper limit of the operator-required vehicle drive force used by the shift control portion, while the output of the engine is limited by the engine output limiting portion as a result of plugging of the filter. Accordingly; the control apparatus prevents an erroneous shifting control of the automatic transmission due to the use of the actual value of the operator-required vehicle drive force, which erroneous shifting control would take place in the absence of the upper limit to be set by the upper limit setting portion. Thus, the present control apparatus permits reduction of a shifting shock of the automatic transmission and its required shifting time, ensuring adequate shifting performance of the automatic transmission.

In the second mode of the invention, the upper limit of the operator-required vehicle drive force is gradually increased after the limitation of the output of the engine is terminated, so that the automatic transmission is adequately shifted according to an increase of the output of the engine after termination of the limitation of the output of the engine.

The control apparatus according to the fourth mode of the invention is configured such that the engine output limiting portion has the filter recovering function for automatically recovering the filter, so that the engine output limiting portion limits the output of the engine by performing the filter recovering function, or by implementing the control for limiting the output of the engine while at the same time performing the filter recovering function. Accordingly, the control apparatus permits efficient elimination of plugging of the filter to minimize a need of limiting the output of the engine, while at the same time preventing erroneous shifting controls of the step-variable transmission portion and the transmission device due to the limitation of the output of the engine during limitation of the upper limit of the operator-required vehicle drive force.

The control apparatus according to the fifth mode of the invention is used to control a hybrid vehicle wherein the automatic transmission of the vehicle is the transmission device including the electrically controlled continuously-variable transmission portion and the mechanically operated step-variable transmission portion, and the vehicle driving electric motor is connected to an intermediate power transmitting member disposed between the electrically controlled continuously-variable transmission portion and the mechanically operated step-variable transmission portion. The control apparatus for this hybrid vehicle is configured such that the overall speed position shifting control portion implements the shifting control of the continuously-variable transmission portion concurrently with the shifting control of the step-variable transmission portion by the step-variable shifting control portion, to shift the transmission device to the selected one of the overall speed positions. Further, the upper limit setting portion is configured to set the upper limit of the operator-required vehicle drive force used commonly by both of the step-variable shifting control portion and the overall speed position shifting control portion, on the basis of the output of the drive power source as a whole including the vehicle driving electric motor, which output is limited as a result of the limitation of the output of the engine by the engine output limiting portion. Accordingly, concurrent or cooperative shifting controls of the step-variable transmission portion and the continuously-variable transmission portion by the respective step-variable shifting control portion and overall speed position shifting control portion can be adequately implemented to shift the transmission device to the selected one of the overall speed positions. In this respect, it is noted that the step-variable transmission portion which receives output torques of both of the engine and the vehicle driving electric motor is relatively likely to suffer from a shifting shock. However, the upper limit of the operator-required vehicle drive force is set on the basis of the output limitation of the drive power source as a whole, so that a risk of generation of the shifting shock of the step-variable transmission portion can be effectively reduced.

### BRIEF DESCRIPTION OF THE DRAWINGS

FIG. 1 is a schematic view showing an arrangement of a drive system of a vehicle to be controlled by a control apparatus according to one embodiment of the present invention, and major control functions and control portions of the control apparatus;

FIG. 2 is a table indicating a relationship between AT gear positions of a mechanically operated step-variable transmission portion shown in FIG. 1 and combinations of coupling devices placed in engaged states to establish the respective AT gear positions;

FIG. 3 is a collinear chart indicating a relationship among rotating speeds of rotary elements of an electrically controlled continuously-variable transmission portion and the mechanically operated step-variable transmission portion;

FIG. 4 is a table indicating an example of a plurality of overall speed positions of a transmission device in relation to the gear positions of the step-variable transmission portion;

FIG. 5 is a view indicating some examples of the gear positions of the mechanically operated step-variable transmission portion and some examples of the overall speed positions of the transmission device, on a collinear chart similar to that of FIG. 3;

FIG. 6 is a view illustrating examples of an AT gear position shifting map and an overall speed position shifting map used to shift up and down the transmission device;

FIG. 7 is a flow chart illustrating steps of an upper limit setting control routine executed by an upper limit setting portion of the control apparatus of FIG. 1, to set an upper limit of an accelerator pedal operation amount; and

FIG. 8 is a time chart illustrating an example of changes of various parameters when the upper limit setting control routine illustrated in the flow chart of FIG. 7 is executed.

### DETAILED DESCRIPTION OF PREFERRED EMBODIMENT

An engine to be controlled by the control apparatus according to the present invention is an internal combustion engine such as a gasoline engine or a diesel engine, which generates a drive force by combustion of a fuel. The engine has an exhaust pipe provided with a filter such as a GPF (gasoline particular filter) or a DPF (diesel particular filter). The control apparatus according to the invention is applicable to an engine-drive vehicle provided with only the engine as the drive power source, but may be applicable to a hybrid vehicle provided with a vehicle driving electric motor in addition to the engine. The vehicle is preferably provided with an automatic transmission including a mechanically operated step-variable transmission portion of a planetary gear type or a parallel-axes type, which includes a plurality of frictional coupling devices which are selectively placed in their engaged and released states to establish a selected one of a plurality of gear positions (speed positions) having respective speed ratio values. However, the automatic transmission may include a mechanically operated continuously-variable transmission portion of a belt-and-pulley type, or an electrically controlled continuously-variable transmission portion configured to continuously change the operating speed of the engine by controlling a torque of a differential motor/generator. The speed ratio of those continuously-variable transmission portions may be continuously changed according to a continuously variable shifting control, but may be changed in steps to a selected one of a plurality of overall speed positions having respective speed ratio values, like the step-variable transmission portion.

The above-described engine output limiting portion to limit the output of the engine when the filter is plugged with the particular substances accumulated therein may be configured to perform a filter recovering function for automatically recovering the filter by controlling the engine so as to facilitate burning of the particular substances accumulated in the filter, during running of the vehicle, so that the output of the engine is limited as a result of the filter recovering function performed by the engine output limiting portion. Alternatively, however, the engine output limiting portion may be configured to merely limit the output of the engine for the purpose of protecting the engine, not for the particular purpose of recovering the filter. The filter recovering function per se does not necessarily result in the limitation of the engine output. The engine output limiting portion may also be configured to implement a control for limiting the engine output to or below a predetermined value while at the same time performing the filter recovering function. The limitation of the engine output may contribute to recovering of the filter.

A determination as to whether the filter has been plugged or clogged may be made depending upon whether a pressure difference across the filter is larger than a predetermined threshold value, or alternatively be made on the basis of a running condition of the vehicle such as an accumulative running distance of the vehicle or an accumulative operating time of the engine. The filter recovering function can be performed by various controls of the engine implemented to facilitate the burning of the particular substances accumulated in the filer, during running of the vehicle. These controls include, for example: a control to increase an amount of injection of a fuel into the engine; a control to adjust an air-fuel mixture into a fuel-rich state; a control to retard an ignition timing of the engine; a control to raise a lower limit of the operating speed of the engine; a control to limit the output of the engine; and a fuel-cut control of the engine. Some of those controls are implemented with limitation of the output of the engine. The upper limit to which the output of the engine is limited by the engine output limiting portion may be a predetermined fixed value irrespective of the running condition of the vehicle such as its running speed, but may be changed according to the running condition of the vehicle, the degree of plugging of the filter, and the specific control performed to recover the filter.

When the engine output limiting portion limits the output of the engine, the engine output limiting portion sets an upper limit of the required vehicle drive force used to control the shifting action of the automatic transmission. This upper limit of the required vehicle drive force corresponds to an upper limit of the output (torque) of the engine. Where the vehicle drive power source includes a vehicle driving electric motor, for example, the upper limit of the required vehicle drive force is preferably determined on the basis of an upper limit of the output of the vehicle drive power source as a whole. The upper limit of the required vehicle drive force is constant where the upper limit of the output of the engine is a constant value. Where the upper limit of the output of the engine is changed depending upon the running condition of the vehicle, the upper limit of the required vehicle drive force is preferably changed on the basis of the upper limit of the output of the engine, and according to a map or an arithmetic equation representative of a relationship between the engine output upper limit and the upper limit of the required vehicle drive force.

It is preferable to gradually increase the upper limit of the required vehicle drive force after the limitation of the output of the engine by the engine output limiting portion is terminated. However, the upper limit of the required vehicle drive force may be instantly reset upon termination of the limitation of the output of the engine. Further, the upper limit of the required vehicle drive force may be otherwise reset, for instance, reset a predetermined delay time after the moment of termination of the limitation of the output of the engine, in view of a delayed control response of the engine output.

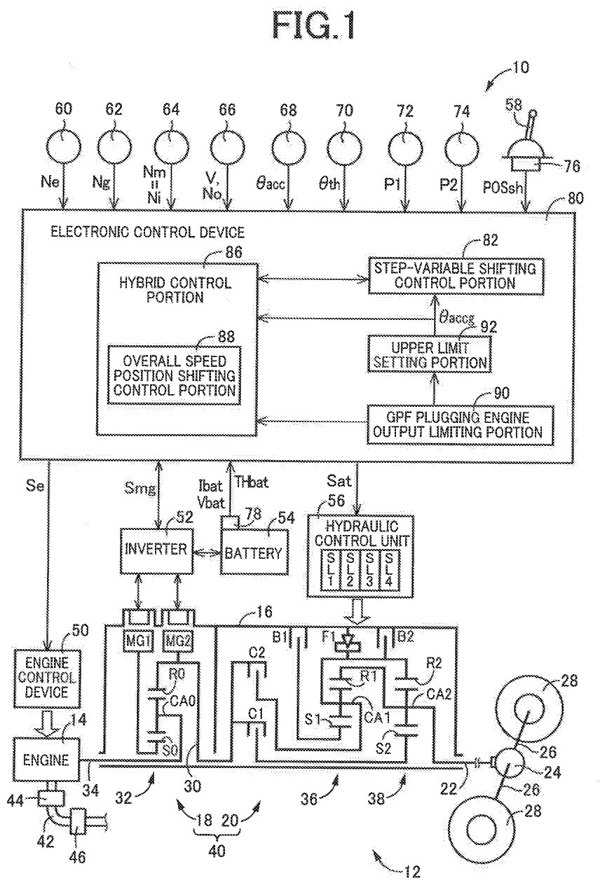

Referring to the drawings, a preferred embodiment of one embodiment of the present invention will be described in detail. Reference is first made to FIG. 1, which is the schematic view showing an arrangement of a drive system 12 of a vehicle 10 to be controlled by a control apparatus according to the present invention, and major control functions and control portions of the control apparatus. As shown in FIG. 1, the vehicular drive system 12 is provided with an engine 14 functioning as a vehicle drive power source, an electrically controlled continuously-variable transmission portion 18, and a mechanically operated step-variable transmission portion 20. The continuously-variable transmission portion 18 and the step-variable transmission portion 20 are disposed in series with each other within a stationary member in the form of a transmission casing 16 fixed to a body of the vehicle 10 such that the transmission portions 18 and 20 are disposed coaxially with each other on a common axis. The electrically controlled continuously-variable transmission portion 18 is connected directly, or indirectly through a damper (not shown), to the engine 14, while the mechanically operated step-variable transmission portion 20 is connected to an output rotary member of the electrically controlled continuously-variable transmission portion 18. The vehicular drive system 12 is further provided with a differential gear mechanism 24 connected to an output rotary member in the form of an output shaft 22 of the mechanically operated step-variable transmission portion 20, and a pair of axles 26 connected to the differential gear mechanism 24. In the vehicular drive system 12, a drive force generated by the engine 14 and a second motor/generator MG2 (described below) is transmitted to the mechanically operated step-variable transmission portion 20, and is transmitted from the mechanically operated step-variable transmission portion 20 to left and right drive wheels 28 of the vehicle 10 through the differential gear mechanism 24 and other devices. The vehicular drive system 12 is suitably used in the vehicle 10 of an FR type (front-engine rear-drive type) in which the axis of the engine 14 is parallel to the longitudinal direction of the vehicle 10. It is noted that the transmission casing 16 will be hereinafter referred to as “casing 16”, while the electrically controlled continuously-variable transmission portion 18 and the mechanically operated step-variable transmission portion 20 are hereinafter referred to respectively as the continuously-variable transmission portion 18 and the step-variable transmission portion 20. It is also noted that the drive force is considered equivalent to a torque or power, unless otherwise specifically distinguished from each other. It is further noted that the continuously-variable and step-variable transmission portions 18 and 20 are constructed substantially symmetrically with each other about the above-indicated common axis, and that FIG. 1 does not show the lower halves of the transmission portions 18 and 20. A crankshaft of the engine 14 and a connecting shaft 34 described below are coaxial with the above-indicated common axis.

The engine 14 is the drive power source to drive the vehicle 10, which is a known internal combustion engine such as a gasoline engine or a diesel engine, which generates the drive force by combustion of a fuel. In the present embodiment, the engine 14 is a gasoline engine using a gasoline as the fuel. An engine torque Te which is an output torque of this engine 14 is controlled by an engine control device 50 which is controlled by an electronic control device 80 described below. The engine control device 50 includes an electronic throttle valve, a fuel injection device and an igniting device, which are provided on the vehicle 10. In the present embodiment, the engine 14 is connected to the continuously-variable transmission portion 18, without a fluid-operated type power transmitting device such as a torque converter or a fluid coupling being disposed between the engine 14 and the continuously-variable transmission portion 18.

The continuously-variable transmission portion 18 is provided with: a first motor/generator MG1; a power distributing mechanism in the form of a differential mechanism 32 configured to mechanically distribute the drive force of the engine 14 to the first motor/generator MG1, and to an intermediate power transmitting member 30 which is the output rotary member of the continuously-variable transmission portion 18. The second motor/generator MG2 is operatively connected to the intermediate power transmitting member 30 in a power transmittable manner. The continuously-variable transmission portion 18 is an electrically controlled continuously-variable transmission wherein a differential state of the differential mechanism 32 is controllable by controlling an operating state (torque, etc.) of the first motor/generator MG1. The first motor/generator MG1 functions as a differential motor/generator which permits controlling of an engine speed Ne, namely, an operating speed of the engine 14. On the other hand, the second motor/generator MG2 is a motor/generator which functions as the vehicle drive power source, namely, a vehicle driving electric motor. The vehicle 10 is a hybrid vehicle provided with the vehicle drive power source in the form of the engine 14 and the second motor/generator MG2.

Each of the first motor/generator MG1 and the second motor/generator MG2 is an electrically operated rotary device having a function of an electric motor and a function of an electric generator. The first motor/generator MG1 and the second motor/generator MG2 are connected to an electric power storage device in the form of a battery 54 through an inverter 52. The inverter 52 and the battery 54 are provided on the vehicle 10, and the inverter 52 is controlled by the above-indicated electronic control device 80, to control an output torque of the first motor/generator MG1, namely, an MG1 torque Tg, and an output torque of the second motor/generator MG2, namely, an MG2 torque Tm. Positive values of the MG1 torque Tg and MG2 torque Tm acting to accelerate the vehicle 10 are vehicle driving torques, while negative values of the MG1 torque Tg and MG2 torque Tm acting to decelerate the vehicle 10 are regenerative torques. The battery 54 is the electric power storage device to and from which an electric power is supplied from and to the first motor/generator MG1 and the second motor/generator MG2.

The differential mechanism 32 is a planetary gear set of a single-pinion type having a sun gear S0, a carrier CA0 and a ring gear R0. The carrier CA0 is operatively connected to the engine 14 through the connecting shaft 34 in a power transmittable manner, and the sun gear S0 is operatively connected to the first motor/generator MG1 in a power transmittable manner, while the ring gear R0 is operatively connected to the intermediate power transmitting member 30 in a power transmittable manner. In the differential mechanism 32, the carrier CA0 functions as an input rotary element, and the sun gear S0 functions as a reaction rotary element, while the ring gear R0 functions an output rotary element.

The step-variable transmission portion 20 is a mechanically operated transmission mechanism functioning as a step-variable transmission constituting a part of a power transmitting path between the intermediate power transmitting member 30 and the drive wheels 28, namely, a mechanically operated transmission mechanism constituting a part of a power transmitting path between the continuously-variable transmission portion 18 and the drive wheels 28. The intermediate power transmitting member 30 also functions as an input rotary member of the step-variable transmission portion 20. The intermediate power transmitting member 30 is connected to the second motor/generator MG2 such that the intermediate power transmitting member 30 and a rotor of the second motor/generator MG2 are rotated as a unit. Further, the engine 14 is connected to an input rotary member of the continuously-variable transmission portion 18. Accordingly, the step-variable transmission portion 20 is an automatic transmission constituting a part of a power transmitting path between the drive power source in the form of the second motor/generator MG2 and the engine 14, and the drive wheels 28. The intermediate power transmitting member 30 is a power transmitting member for transmitting the drive force of the drive power source to the drive wheels 28. The step-variable transmission portion 20 is a known automatic transmission of a planetary gear type which is provided with a plurality of planetary gear sets in the form of a first planetary gear set 36 and a second planetary gear set 38, and a plurality of coupling devices in the form of a clutch C1, a clutch C2, a brake B1 and a brake B2 as well as a one-way clutch F1. The clutches C1 and C2 and the brakes B1 and B2 will be hereinafter simply referred to as “coupling devices CB” unless otherwise specified.

Each of the coupling devices CB is a hydraulically operated frictional coupling device in the form of a multiple-disc type or a single-disc type clutch or brake, or a band brake, which is operated by a hydraulic actuator. The coupling devices CB are selectively placed in their engaged or released states with their torque capacities or engaging torques Tcb being changed according to engaging hydraulic pressures PRcb applied thereto, which are regulated by respective solenoid-operated valves SL1-SL4 incorporated within a hydraulic control unit 56. The engaging torques Tcb and the engaging hydraulic pressures PRcb are substantially proportional to each other, after the engaging hydraulic pressures PRcb have been raised to fill the hydraulic actuators for the coupling devices CB.

In the step-variable transmission portion 20, selected ones of rotary elements of the first and second planetary gear sets 36 and 38 are connected to each other or to the intermediate power transmitting member 30, casing 16 or output shaft 22, either directly or indirectly through the coupling devices CB or the one-way clutch F1. The first planetary gear set 36 is provided with the rotary elements in the form of a sun gear S1, a carrier CA1 and a ring gear R1, while the second planetary gear set 38 is provided with the rotary elements in the form of a sun gear S2, a carrier CA2 and a ring gear R2.

The step-variable transmission portion 20 is shifted to a selected one of four gear positions (speed positions) by engaging actions of selected ones of the coupling devices CB. These four gear positions have respective different speed ratios γat (=AT input speed Ni/AT output speed No). Namely, the step-variable transmission portion 20 is shifted up and down from one gear position to another by placing selected ones of the coupling devices CB in their engaged states. That is, the step-variable transmission portion 20 is a step-variable automatic transmission having a plurality of gear or speed positions. In the present embodiment, the plurality of gear positions established by the step-variable transmission portion 20 will be referred to as “AT gear positions”. The AT input speed Ni is a rotating speed of the input rotary member of the step-variable transmission portion 20, that is, an input speed of the step-variable transmission portion 20, which is equal to a rotating speed of the intermediate power transmitting member 30, and to an MG2 speed Nm which is an operating speed of the second motor/generator MG2. On the other hand, the AT output speed No is a rotating speed of the output shaft 22 of the step-variable transmission portion 20, that is, an output speed of the step-variable transmission portion 20, which is considered to be an output speed of a transmission device 40 which consists of the continuously-variable transmission portion 18 and the step-variable transmission portion 20. In the present embodiment, the transmission device 40 as a whole consisting of the step-variable and continuously-variable transmission portions 20 and 18 serves as an automatic transmission constituting the part of the power transmitting path between the engine 14 and the drive wheels 28. However, both of the step-variable and continuously-variable transmission portions 20 and 18 can be respectively considered as two automatic transmissions.

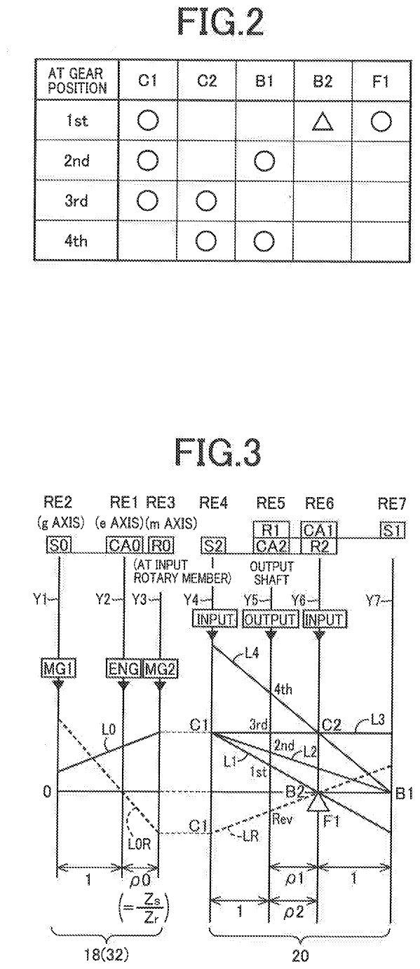

Reference is now made to FIG. 2, which is the table indicating the relationship between the first through fourth AT gear positions of the step-variable transmission portion 20 and combinations of the coupling devices CB placed in the engaged states to establish the respective AT gear positions. In the table of FIG. 2, the four AT gear positions are respectively represented by “1^{st}”, “2^{nd}”, “3^{rd}” and “4^{th}”. The first speed AT gear position “1^{st}” has a highest speed ratio γat, and the speed ratios γat of the four AT gear positions decrease in the direction from the first speed AT gear position (lowest-speed gear position) “1^{st}” toward the fourth speed AT gear position (highest-speed gear position) “4^{th}”. In the table, “O” indicates the engaged states of the coupling devices CB, “Δ” indicates the engaged states of the coupling device B2 during application of an engine brake to the vehicle 10 or during a coasting shift-down action of the step-variable transmission portion 20 during a coasting run of the vehicle 10, while the blank indicates the released state of the coupling devices CB. The one-way clutch F1 indicated above is disposed parallel to the brake B2 which is placed in the engaged state to establish the first speed AT gear position “1^{st}”, so that the brake B2 is not required to be placed in the engaged state upon starting or acceleration of the vehicle 10. It is noted that the step-variable transmission portion 20 is placed in a neutral position when all of the coupling devices CB are placed in the released states.

The step-variable transmission portion 20 is shifted up or down to establish a newly selected one of the four AT gear positions, according to an operation amount of an accelerator pedal by an operator of the vehicle 10 and a running speed V of the vehicle 10, with a releasing action of one of the coupling devices CB and a concurrent engaging action of another coupling device CB, which concurrent releasing and engaging actions are controlled by the above-indicated electronic control device 80. The above-indicated one coupling device CB was placed in the engaged state before the step-variable transmission portion 20 is shifted to establish the newly selected AT gear position, while the above-indicated another coupling device CB was placed in the released state before the step-variable transmission portion 20 is shifted to establish the newly selected AT gear position. Thus, the step-variable transmission portion 20 is shifted up or down from one of the AT gear positions to another by so-called “clutch-to-clutch” shifting operation, namely, concurrent releasing and engaging actions of the selected two coupling devices CB. It is noted that the shift-down action of the step-variable transmission portion 20 from the second speed AT gear position “2^{nd}” to the first speed AT gear position “1^{st}” can also be implemented with the automatic engaging action of the one-way clutch F1 which takes place concurrently with the releasing action of the brake B1.

The collinear chart of FIG. 3 indicates a relationship among rotating speeds of the rotary elements of the continuously-variable transmission portion 18 and the step-variable transmission portion 20. In this collinear chart of FIG. 3, three vertical lines Y1, Y2 and Y3 corresponding to the respective three rotary elements of the differential mechanism 32 of the continuously-variable transmission portion 18 respectively represent a “g” axis representing the rotating speed of a second rotary element RE2 in the form of the sun gear S0, an “e” axis representing the rotating speed of a first rotary element RE1 in the form of the carrier CA0, and an “m” axis representing the rotating speed of a third rotary element RE3 in the form of the ring gear R0. Further, four vertical lines Y4, Y5, Y6 and Y7 corresponding to the respective four rotary elements of the step-variable transmission portion 20 respectively represent an axis representing the rotating speed of a fourth rotary element RE4 in the form of the sun gear S2, an axis representing the rotating speed of a fifth rotary element RE5 in the form of the ring gear R1 and the carrier CA2 fixed to each other, namely, the rotating speed of the output shaft 22, an axis representing the rotating speed of a sixth rotary element RE6 in the form of the carrier CA1 and the ring gear R2 fixed to each other, and an axis representing the rotating speed of a seventh rotary element RE7 in the form of the sun gear S1. The distances between the adjacent ones of the vertical lines Y1, Y2 and Y3 are determined by a gear ratio ρ0 of the differential mechanism 32, while the distances between the adjacent ones of the vertical lines Y4-Y7 are determined by gear ratios p1 and p2 of the respective first and second planetary gear sets 36 and 38. Where the distance between the axis representing the rotating speed of the sun gear S0, S1, S2 and the axis representing the rotating speed of the carrier CA0, CA1, CA2 corresponds to “1”, the distance between the axis representing the rotating speed of the carrier CA0, CA1, CA2 and the axis representing the rotating speed of the ring gear R0, R1, R2 corresponds to the gear ratio ρ of the planetary gear set (=number of teeth Zs of the sun gear/number of teeth Zr of the ring gear).

Referring to the collinear chart of FIG. 3, the differential mechanism 32 of the continuously-variable transmission portion 18 is arranged such that the engine 14 (represented as “ENG” in the collinear chart) is connected to the first rotary element RE1, and the first motor/generator MG1 (represented as “MG1” in the collinear chart) is connected to the second rotary element RE2, while the second motor/generator MG2 (represented as “MG2” in the collinear chart) is connected to the third rotary element RE3 which is rotated together with the intermediate power transmitting member 30. Thus, a rotary motion of the engine 14 is transmitted to the step-variable transmission portion 20 through the intermediate power transmitting member 30.

The step-variable transmission portion 20 is arranged such that the fourth rotary element RE4 is selectively connected to the intermediate power transmitting member 30 through the clutch C1, the fifth rotary element RE5 is connected to the output shaft 22, the sixth rotary element RE6 is selectively connected to the intermediate power transmitting member 30 through the clutch C2 and is selectively connected to the casing 16 through the brake B2, and the seventh rotary element RE7 is selectively connected to the casing 16 through the brake B1. In a part of the collinear chart corresponding to the step-variable transmission portion 20, straight lines L1, L2, L3, L4 and LR intersecting the vertical line Y5 represent the rotating speeds of the output shaft 22 in the respective first, second, third and fourth speed AT gear positions “1^{st}”, “2^{nd}”, “3^{rd}” and “4^{th}”, and a rear drive position “Rev”.

Solid straight lines L0, L1, L2, L3 and L4 shown in the collinear chart of FIG. 3 indicate the relative rotating speeds of the rotary elements in a hybrid drive mode in which the vehicle 10 is driven in the forward direction with at least the engine 14 being operated as the drive power source. In the differential mechanism 32 placed in this hybrid drive mode, the engine torque Te is applied to the carrier CA0 while a reaction torque (i.e. regenerative torque) which is a negative torque generated by the first motor/generator MG1 is applied to the sun gear S0 so as to rotate the sun gear S0 in the positive direction. As a result, a directly transmitted engine torque Td (=Te/(1 p0)=−(1/p0)×Tg) which is a positive torque is applied to the ring gear R0 so as to rotate the ring gear R0 in the positive direction. The vehicle 10 is driven in the forward direction with a vehicle drive torque which is a sum of the directly transmitted engine torque Td and the MG2 torque Tm and which is transmitted to the drive wheels 28 through the step-variable transmission portion 20 selectively placed in one of the first through fourth speed AT gear positions according to an operator-required vehicle drive force. At this time, the first motor/generator MG1 functions as an electric generator operated in the positive direction to generate a negative torque. An electric power Wg generated by the first motor/generator MG1 is stored in the battery 54 or consumed by the second motor/generator MG2. The second motor/generator MG2 is operated to generate the MG2 torque Tm, with all or a part of the electric power Wg generated by the first motor/generator MG1, or a sum of the generated electric power Wg and the electric power supplied from the battery 54.

In the differential mechanism 32 placed in a motor drive mode in which the vehicle 10 is driven with a drive force generated by the second motor/generator MG2 operated as the drive power source while the engine 14 is held at rest, the carrier CA0 is held stationary while the MG2 torque Tm which is a positive torque is applied to the ring gear R0 so as to rotate the ring gear R0 in the positive direction. At this time, the first motor/generator MG1 connected to the sun gear S0 is placed in a non-load state and freely operated in the negative direction. Namely, in the motor drive mode, the engine 14 is held in the non-operated state, so that the engine speed Ne is kept substantially zero, and the vehicle 10 is driven in the forward direction with the MG2 torque Tm (positive forward driving torque), which is transmitted as a forward drive torque to the drive wheels 28 through the step-variable transmission portion 20 placed in one of the first through fourth speed AT gear positions.

Broken straight lines L0R and LR shown in the collinear chart of FIG. 3 represent the relative rotating speeds of the various rotary elements of the continuously-variable and step-variable transmission portions 18 and 20 during running of the vehicle 10 in the rearward direction in the motor drive mode. During this running of the vehicle 10 in the rearward direction in the motor drive mode, the MG2 torque Tm which is a negative torque is applied to the ring gear R0 so as to rotate the ring gear R0 in the negative direction, and is transmitted as the rearward driving torque to the drive wheels 28 through the step-variable transmission portion 20 placed in the first speed AT gear position. The vehicle 10 can be driven in the rearward direction with the rearward driving MG2 torque Tm which is the negative torque generated by the second motor/generator MG2 under the control of the electronic control device 80 and which is opposite to the positive forward driving torque generated while the step-variable transmission portion 20 is placed in the forward low-speed AT gear position, for instance, in the first speed AT gear position “1^{st}”. The forward driving MG2 torque Tm is the positive vehicle driving torque for rotating the drive wheels 28 in the positive direction, while the rearward driving MG2 torque Tm is the negative vehicle driving torque for driving the drive wheels 28 in the negative direction. Thus, the vehicle 10 is driven in the rearward direction with the negative MG2 torque Tm generated while the step-variable transmission portion 20 is placed in the suitably selected forward driving AT gear position, which is also used to drive the vehicle 10 in the forward direction. In the first speed AT gear position “1^{st}” established to drive the vehicle 10 in the rearward direction, the clutch C1 and the brake B2 are placed in their engaged states. In the hybrid drive mode, too, the second motor/generator MG2 can be operated in the negative direction, as indicated by the straight line L0R, so that the vehicle 10 can be driven in the rearward direction in the hybrid drive mode, as in the motor drive mode.

In the vehicular drive system 12, the continuously-variable transmission portion 18 functions as an electrically controlled transmission mechanism provided with the differential mechanism 32 the differential state of which is controlled by controlling the operating state of the first motor/generator MG1, and which has the three rotary elements, that is, the first rotary element RE1 in the form of the carrier CA0 to which the engine 14 is operatively connected in a power transmittable manner, the second rotary element RE2 in the form of the sun gear S0 to which the first motor/generator MG1 is operatively connected in a power transmittable manner, and the third rotary element RE3 in the form of the ring gear R0 to which the intermediate power transmitting member 30 is operatively connected in a power transmittable manner. The continuously-variable transmission portion 18 is operated as an electrically controlled continuously-variable transmission a speed ratio γ0(=Ne/Nm) of which is variable. The speed ratio is a ratio of the engine speed Ne equal to a rotating speed of the connecting shaft 34 (which is the input rotary member of the continuously-variable transmission portion 18), with respect to the MG2 speed Nm equal to the rotating speed of the intermediate power transmitting member 30 (which is the output rotary member of the continuously-variable transmission portion 18).

In the hybrid drive mode, for instance, the rotating speed of the sun gear S0 is raised or lowered by controlling an operating speed of the first motor/generator MG1 while the rotating speed of the ring gear R0 is determined by a rotating speed of the drive wheels 28 with the step-variable transmission portion 20 placed in one of the AT gear positions, so that the rotating speed of the carrier CA0 (namely, engine speed Ne) is accordingly raised or lowered. In the hybrid drive mode, therefore, the engine 14 can be operated in an efficiently operating state. That is, the step-variable transmission portion 20 to be placed in a selected one of the AT gear positions and the continuously-variable transmission portion 18 functioning as a continuously-variable transmission cooperate to provide the transmission device 40 in which the continuously-variable transmission portion 18 and the step-variable transmission portion 20 are disposed in series with each other and which functions as a continuously-variable transmission as a whole.

Alternatively, the continuously-variable transmission portion 18 can be shifted like a step-variable transmission. Accordingly, the transmission device 40 constituted by the step-variable transmission portion 20 to be placed in one of the AT gear positions and the continuously-variable transmission portion 18 which can be shifted like the step-variable transmission can be shifted like a step-variable transmission as a whole. That is, the step-variable transmission portion 20 and the continuously-variable transmission portion 18 can be controlled to selectively establish a plurality of speed positions (hereinafter referred to as “overall speed positions”) having respective different values of a speed ratio γt (=Ne/No) which is a ratio of the engine speed Ne to the output speed No. The speed ratio γt is an overall speed ratio of the transmission device 40 consisting of the continuously-variable transmission portion 18 and the step-variable transmission portion 20 which are disposed in series with each other. The overall speed ratio γt is equal to a product of the speed ratio γ0 of the continuously-variable transmission portion 18 and the speed ratio γat of the step-variable transmission portion 20, namely, γt =γ0×γat.

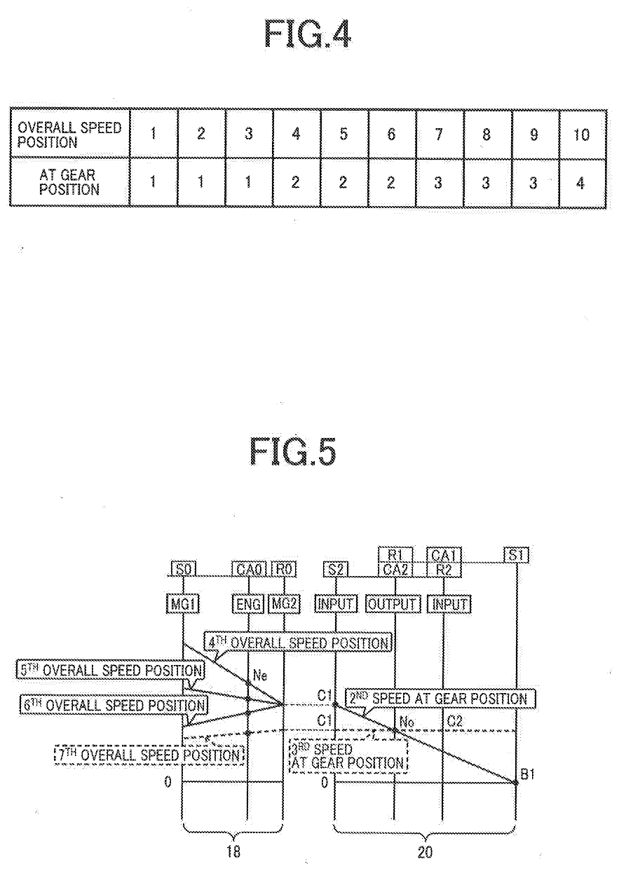

At least one overall speed position is provided for each of the four AT gear positions of the step-variable transmission portion 20, with a combination of each AT gear position with at least one of the different speed ratio values γ0 of the continuously-variable transmission portion 18. FIG. 4 is the table indicating an example of the overall speed positions of the transmission device 40, wherein first through third overall speed positions are established for the first speed AT gear position, fourth through sixth overall speed positions are established for the second speed AT gear position, seventh through ninth overall speed positions are established for the third speed AT gear position, and a tenth overall speed position is established for the fourth speed AT gear position.

FIG. 5 is the view indicating some examples of the AT gear positions of the step-variable transmission portion 20 and some examples of the overall speed positions of the transmission device 40, on a collinear chart similar to that of FIG. 3. In the collinear chart of FIG. 5, solid lines indicate the fourth through sixth overall speed positions established when the step-variable transmission portion 20 is placed in the second speed AT gear position. In the transmission device 40, the continuously-variable transmission portion 18 is controlled to control the engine speed Ne with respect to the output speed No for establishing the predetermined overall speed ratio values γt, to thereby establish the overall speed position or positions for each of the AT gear positions. A broken line indicates the seventh overall speed position established when the step-variable transmission portion 20 is placed in the third speed AT gear position. In the transmission device 40, the continuously-variable transmission portion 18 is controlled according to the selected one of the AT gear positions, for shifting the transmission device 40 from one of the overall speed positions to another.

Referring back to FIG. 1, the vehicle 10 is provided with a shift lever 58, which is a manually operated shifting member operable by the vehicle operator to a selected one of a plurality of operating positions POSsh, which include a parking position P, a reverse-drive position R, a neutral position N and a forward-drive position D, for example. The parking position P is selected for parking the vehicle 10, to place the transmission device 40 in a neutral state and to mechanically lock the output shaft 22. In the neutral state of the transmission device 40, the first motor/generator MG1 is placed in a non-load state in which the rotor of the first motor/generator MG1 is freely rotatable and does not generate a reaction torque to the engine torque Te, so that the continuously-variable transmission portion 18 is not able to transmit the engine torque Te, while at the same time the second motor/generator MG2 is placed in a non-load state, so that, the transmission device 40 is placed in a power cutoff state. The transmission device 40 may be placed in the neutral state by placing all of the coupling devices CB of the mechanically operated step-variable transmission portion 20. In the mechanically locked state of the output shaft 22, the output shaft 22 is held stationary with a parking lock mechanism (not shown), for instance.

The reverse-drive position R is selected to drive the vehicle 10 in the rearward direction with the rearward driving MG2 torque Tm while the step-variable transmission portion 20 is placed in the first speed AT gear position. The neutral position N is selected to place the transmission device 40 in the neutral state. The forward-drive position D is selected to drive the vehicle 10 in the forward direction under an automatic shifting control in which the transmission device 40 can be automatically shifted from one of the first through tenth overall speed positions. The automatic shifting control is implemented to establish an automatic shifting mode in which the transmission device 40 is automatically shifted according to an overall speed position shifting map which will be described.

The engine 14 has an exhaust pipe 42 provided with a catalyst 44 and a GPF (gasoline particular filter) 46. The catalyst 44 functions to purify an exhaust emission from the engine 14, by removing hydrocarbon, carbon monoxide, nitrogen oxides, etc. from the exhaust emission, by oxidation and reduction. The GPF 46 is disposed downstream of the catalyst 44. The GPF 46 is a filter to separate particulate substances such as PM (particulate matters) from the exhaust emission. The GPF 46 provided in addition to the catalyst 44 improves a degree of purification of the exhaust emission.

The vehicle 10 is provided with the control apparatus of the present invention in the form of the electronic control device 80 configured to control various devices of the vehicle 10 such as the engine 14, continuously-variable transmission portion 18 and step-variable transmission portion 20. FIG. 1 is the view showing input and output signals of the electronic control device 80, and is a functional block diagram showing major control functions and control portions of the electronic control device 80. For example, the electronic control device 80 is a so-called microcomputer incorporating a CPU, a ROM, a RAM and an input-output interface. The CPU performs various controls of the vehicle 10, by implementing various input signal processings, according to control Programs stored in the ROM, while utilizing a temporary data storage function of the RAM. The electronic control device 80 may be constituted by two or more control units exclusively assigned to perform different controls such as engine controls and transmission shifting controls. The control apparatus of the present invention is mainly comprised of the electronic control device 80.

The electronic control device 80 receives various input signals such as: an output signal of an engine speed sensor 60 indicative of the engine speed Ne; an output signal of an MG1 speed sensor 62 indicative of an MG1 speed Ng which is the operating speed of the first motor/generator MG1; an output signal of an MG2 speed sensor 64 indicative of the MG2 speed Nm which is the AT input speed Ni; an output signal of an output speed sensor 66 indicative of the output speed No corresponding to the vehicle running speed V; an output signal of an accelerator pedal operation amount sensor 68 indicative of an operation amount θacc of a vehicle accelerating member in the form of the accelerator pedal; an output signal of a throttle valve opening angle sensor 70 indicative of an angle θth of opening of the above-indicated electronic throttle valve; an output signal of a first pressure sensor 72 indicative of an upstream-side pressure P1 on an upstream side of the GPF 46; an output signal of a second pressure sensor 74 indicative of a downstream-side pressure P2 on a downstream side of the GPF 46; an output signal of a shift position sensor 76 indicative of the presently selected operating position POSsh of the shift lever 58; and output signals of a battery sensor 78 indicative of a temperature THbat, a charging/discharging electric current Ibat and a voltage Vbat of the battery 54. The operation amount θacc of the vehicle accelerating member represents a degree of acceleration of the vehicle 10 required by the vehicle operator, and therefore a vehicle drive force or a vehicle output which is required by the vehicle operator. A charged state value SOC[%] of the battery 54 (an amount of electric power stored in the battery 54) is calculated on the basis of the charging/discharging electric current that and the voltage Vbat of the battery 54.

The electronic control device 80 generates various output signals such as: engine control command signals Se to be applied to an engine control device 50, for controlling the engine 14; motor/generator control command signals Smg to be applied, to the inverter 52, for controlling the first motor/generator MG1 and the second motor/generator MG2; and hydraulic control command signals Sat to be applied to the hydraulic control unit 56, for controlling the operating states of the coupling devices CB. The hydraulic control command signals Sat are command signals for controlling the solenoid-operated valves SL1-SL4 to regulate the engaging hydraulic pressures PRcb to be applied to the respective hydraulic actuators of the coupling devices CB, for shifting the step-variable transmission portion 20. The electronic control device 80 operates to set a hydraulic pressure command value corresponding to the engaging hydraulic pressure PRcb to be applied to each of the hydraulic actuators, for establishing a desired amount of the engaging torque Tcb of the corresponding coupling device CB, and applies to the hydraulic control unit 56 an electric current or voltage command signal corresponding to the hydraulic pressure command value.

The electronic control device 80 includes a shift control means in the form of a step-variable shifting control portion 82, a hybrid control means in the form of a hybrid control portion 86, an engine output limiting means in the form of a GPF plugging engine output limiting portion 90, and an upper limit setting means in the form of an upper limit setting portion 92. The step-variable shifting control portion 82 is configured to control shifting actions of the mechanically operated step-variable transmission portion 20. The hybrid control portion 86 is configured to control the engine 14, the first motor/generator MG1 and the second motor/generator MG2. The GPF plugging engine output limiting portion 90 is configured to limit the output of the engine 14 when the GPF 46 is in a plugged state. The upper limit setting portion 92 is configured to set an upper limit of the output of the engine 14.

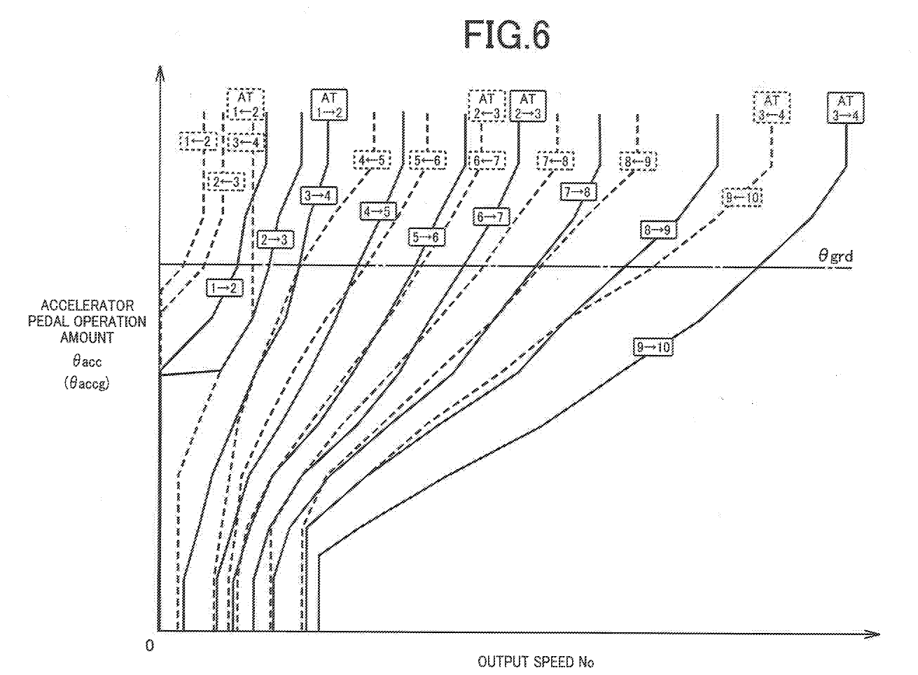

The step-variable shifting control portion 82 is configured to determine a shifting action of the step-variable transmission portion 20 according to a memory-stored AT gear position shifting map obtained by experimentation or determined by an appropriate design theory, and to implement a shifting control for controlling the step-variable transmission portion 20 to perform the determined shifting action. In this shifting control, the step-variable shifting control portion 82 applies the hydraulic control command signals Sat to the hydraulic control unit 56, for commanding the solenoid-operated valves SL1-SL4 to bring the appropriate ones of the coupling devices CB into the released and engaged states, for automatically shifting up or down the step-variable transmission portion 20. The AT gear position shifting map indicated above represents a predetermined relationship between two variables in the form of the output speed No and the accelerator pedal operation amount θacc, which relationship is used to determine a shifting action of the step-variable transmission portion 20 and is represented by shift-up and shift-down shifting lines in a two-dimensional coordinate system in which the output speed No and the accelerator pedal operation amount θacc are taken along respective two axes. FIG. 6 shows an example of the AT gear position shifting map consisting of the shifting lines labeled “AT”. The output speed No may be replaced by the vehicle running speed V, and the accelerator pedal operation amount θacc may be replaced by an operator-required drive torque Tdem. The shifting lines of the AT gear position shifting map consist, of shift-up lines (solid lines) for determining shift-up actions of the step-variable transmission portion 20, and shift-down lines (broken lines) for determining shift-down actions of the step-variable transmission portion 20. Each of the shifting lines is defined by a series of shifting points which are determined such that the step-variable transmission portion 20 should be shifted up or down when the output speed No becomes higher or lower than the shifting point at a given value of the accelerator pedal operation amount θacc, or when the accelerator pedal operation amount θacc becomes larger or smaller than the shifting point at a given value of the output speed No. Described more specifically, the shifting lines are determined such that an AT gear position having relatively large speed ratio γat is selected or established when the accelerator pedal operation amount θacc increases and/or the output speed No decreases. The AT gear position shifting map defines a condition to be satisfied to shift the step-variable transmission portion 20 on the basis of a running state of the vehicle 10 represented by the accelerator pedal operation amount θacc and the output speed No.

The hybrid control portion 86 has a function of an engine control means or portion to control the engine 14, and a function of a motor/generator control means or portion to control the first motor/generator MG1 and the second motor/generator MG2 through the inverter 52. Thus, the hybrid control portion 86 performs hybrid drive controls for controlling the engine 14, first motor/generator MG1 and second motor/generator MG2. The hybrid control portion 86 is configured to calculate an operator-required vehicle drive power Pdem on the basis of the accelerator pedal operation amount θacc and the vehicle running speed V, and according to a predetermined relationship in the form of a drive force map, for instance. In other words, the hybrid control portion 86 calculates the operator-required drive torque Tdem or an operator-required drive force at the present vehicle running speed V. The hybrid control portion 86 generates the engine control command signals Se to control the engine 14, and the motor/generator control command signals Smg to control the first motor/generator MG1 and the second motor/generator MG2, for establishing the operator-required vehicle drive power Pdem. For example, the engine control command signals Se represent an engine power Pe which is the torque Te of the engine 14 at its present operating speed Ne. For example, the motor/generator control command signals Smg represent an electric power amount Wg to be generated by the first motor/generator MG1 to generate the reaction torque with respect to the engine torque Te, namely, the MG1 torque Tg at the present MG1 speed Ng, and an electric power amount Wm to be consumed by the second motor/generator MG2 to generate the MG2 torque Tm at the present MG2 speed Nm. It is noted that the hybrid control portion 86 functions as a drive power source control portion configured to control an output of the drive power source in the form of the engine 14 and the second motor/generator MG2 on the basis of the accelerator pedal operator amount θacc corresponding to the required drive force.

When the transmission device 40 as a whole is operated as the continuously-variable transmission while the continuously-variable transmission portion 18 is operated as the continuously-variable transmission, for instance, the hybrid control portion 86 controls the engine 14 and the electric power amount Wg to be generated by the first motor/generator MG1, so as to establish the engine speed Ne and the engine torque Te for obtaining the engine power Pe to establish the operator-required vehicle drive power Pdem, while taking account of a highest fuel economy point of the engine 14, so that the speed ratio γ0 of the continuously-variable transmission portion 18 is controlled so as to be continuously varied. As a result, the speed ratio γt of the transmission device 40 is controlled while the continuously-variable transmission portion 18 is operated as the continuously-variable transmission.

The hybrid control portion 86 includes an overall speed position shifting control means in the form of an overall speed position shifting control portion 88. This overall speed position shifting control portion 88 is configured to shift the transmission device 40 as a whole as the step-variable transmission while the continuously-variable transmission portion 18 is operated as the step-variable transmission. The overall speed position shifting control portion 88 determines a shifting action of the transmission device 40 according to the above-indicated overall speed position shifting map, and performs a shifting control of the continuously-variable transmission portion 18 to establish a selected one of the plurality of overall speed positions, in cooperation with the step-variable shifting control portion 82 to shift the step-variable transmission portion 20 selectively to the AT gear positions. The plurality of overall speed positions can be established by controlling the first motor/generator MG1 to control the engine speed Ne according to the output speed No so as to maintain the respective speed ratio values γt. Each of the speed ratio values γt of the overall speed positions need not be constant over the entire range of the output speed No, and may have different values in respective regions of the output speed No, or may be limited depending upon upper and lower limits of rotating speeds of various parts of the step-variable transmission portion 20.

Like the AT gear position shifting map, the above-indicated overall speed position shifting map represents a predetermined relationship between the output speed No and the accelerator pedal operation amount θacc. FIG. 6 also shows an example of the overall speed position shifting map. In FIG. 6, solid lines indicate shift-up boundary lines while broken lines indicate shift-down boundary lines. The transmission device 40 consisting of the continuously-variable transmission portion 18 and the step-variable transmission portion 20 which are disposed in series with each other is shifted from one of the overall speed positions to another according to the overall speed position shifting map, as if the transmission device 40 was shifted like a step-variable transmission as a whole. This overall step-variable shifting control to control the shifting actions of the transmission device 40 as the step-variable transmission as a whole may be implemented preferentially to the continuously-variable shifting control of the transmission device 40 as the continuously-variable transmission as a whole, only when a sporty drive mode or any other high-drivability drive mode is selected by the vehicle operator, or only when the operator-required drive torque Tdem is comparatively large, but may be principally implemented except where the overall step-variable shifting control is restricted or inhibited.

The overall speed position shifting control by the overall speed position shifting control portion 88 and the step-variable shifting control by the step-variable shifting control portion 82 are implemented in cooperation with each other. In this embodiment, the ten overall speed positions, that is, the first through tenth overall speed positions are established for the four AT gear positions, that is, the first through fourth speed AT gear positions. The AT gear position shifting map is defined such that an AT gear position shifting operation is performed in synchronization with an overall speed position shifting operation. Described more specifically, the shift-up lines for shifting up the transmission device 40 from the third overall speed position to the fourth overall speed position (3→4), from the sixth overall speed position to the seventh overall speed position (6→7), and from the ninth overall speed position to the tenth overall speed position (9→10) are respectively coincident with the shift-up lines for shifting up the step-variable transmission portion 20 from the first speed AT gear position to the second speed AT gear position (1→2), from the second speed AT gear position to the third speed AT gear position (2→3), and from the third speed AT gear position to the fourth speed AT gear position (3→4). For instance, the overall speed position shift-up line 3→4 is coincident with the AT gear position shift-up line AT1→2, as indicated in FIG. 6. Further, the shift-down lines for shifting down the transmission device 40 from the fourth overall speed position to the third overall speed position (3←4), from the seventh overall speed position to the sixth overall speed position (6←7), and from the tenth overall speed position to the ninth overall speed position (9←10) are respectively coincident with the shift-down lines for shifting down the step-variable transmission portion 20 from the second speed AT gear position to the first speed AT gear position (1←2), from the third speed AT gear position to the second speed AT gear position (2←3), and from the fourth speed AT gear position to the third speed AT gear position (3←4). For instance, the overall speed position shift-down line 3←4 is coincident with the AT gear position shift-down line AT1←2, as also indicated in FIG. 6. Alternatively, a command to shift the step-variable transmission portion 20 may be applied to the step-variable shifting control portion 82 in response to a determination according to the overall speed position shifting map of FIG. 6 that the transmission device 40 should be shifted from one overall speed position to another. Thus, a shift-up action of the transmission device 40 as a whole takes place upon a shift-up action of the step-variable transmission portion 20, and a shift-down action of the transmission device 40 as a whole takes place upon a shift-down action of the step-variable transmission portion 20. The step-variable shifting control portion 82 commands the step-variable transmission portion 20 to perform a shifting action from one AT gear position to another, for shifting the transmission device 40 from one overall speed position to another. Since the AT gear position shifting operation is performed in synchronization with the overall speed position shifting operation, the shifting action of the step-variable transmission portion 20 is performed with a change of the engine speed Ne, so that the vehicle operator is less likely to uncomfortably recognize a shifting shock of the step-variable transmission portion 20. The overall speed position shifting control portion 88 and the step-variable shifting control portion 82 function as respective shifting control portions configured to implement respective shifting controls of the continuously-variable transmission portion 18 and the step-variable transmission portion 20, on the basis of the operator-required vehicle drive force represented by the accelerator pedal operation amount θacc and the vehicle running speed V represented by the output speed No.

The hybrid control portion 86 selectively establishes the motor drive mode or the hybrid drive mode, depending upon the running state of the vehicle 10. For example, the hybrid control portion 86 selects the motor drive mode when the operator-required vehicle drive power Pdem is lower than a predetermined threshold value, that is, within a predetermined motor drive mode range, and selects the hybrid drive mode when the required vehicle drive power Pdem is equal to or higher than the threshold value, that is, within a predetermined hybrid drive mode range. Further, even when the required vehicle drive power Pdem is within the motor drive mode range, the hybrid control portion 86 selects the hybrid drive mode if the electric power amount SOC stored in the battery 54 is smaller than a predetermined engine-starting threshold value. In the motor drive mode, the vehicle 10 is driven with a drive torque generated by the second motor/generator MG2 while the engine 14 is held at rest. In the hybrid drive mode, the engine 14 is operated as needed. The engine-starting threshold value indicated above is predetermined as a lower limit of the electric power amount SOC below which the battery 54 should be charged by starting the engine 14.

The GPF plugging engine output limiting portion 90 is configured to limit the output of the engine 14 when an amount of particulate substances accumulated in the GPF 46 has exceeded a predetermined threshold value, namely, when the GPF 46 has been plugged or clogged with the accumulated particulate substances. A determination as to whether the GPF 46 is plugged or not can be made by determining whether a pressure difference ΔP (=P1−P2) between the upstream-side pressure P1 on the upstream side of the GPF 46 and the downstream-side pressure P2 on the downstream side of the GPF 46 is larger than or equal to a predetermined threshold value ΔPs. The upstream-side and downstream-side pressures P1 and P2 are detected by the respective first and second pressure sensors 72 and 74. The threshold value ΔPs is a predetermined value above which a flow of the exhaust emission from the engine 14 is disturbed by the particulate substances accumulated in the GPF 46 so that the engine 14 cannot be adequately operated. The determination that the GPF 46 is in the plugged state is made where ΔP≥ΔPs. It is noted that the downstream-side pressure P2 may be replaced by the atmospheric pressure, and that the determination as to whether the GPF 46 is in the plugged state can be made on the basis of the running condition of the vehicle 10 such as an accumulative running distance of the vehicle 10 or an accumulative operating time of the engine 14.

When the determination that the GPF 46 is in the plugged state is made, the GPF plugging engine output limiting portion 90 limits the output of the engine 14, preferentially to the output control of the engine 14 by the hybrid control portion 86. The GPF plugging engine output limiting portion 90 may be configured to merely limit the output of the engine 14 for the purpose of protecting the engine 14, by limiting the engine output Te to or below a predetermined upper limit, for example. In the present embodiment, however, the GPF plugging engine output limiting portion 90 is configured to perform a filter recovering function for automatically recovering the GPF filter 46, by controlling the engine 14 so as to facilitate burning of the particulate substances accumulated in the GPF 46, during running of the vehicle 10. The filter recovering function results in limiting the output of the engine 14, or the output of the engine 14 is limited while the filter recovering function is performed. Where the vehicle 10 is driven with the engine 14 used as the drive power source, for instance, the filter recovering function is performed by at least one or a plurality of various controls of the engine 14 such as: a control to increase an amount of injection of a fuel into the engine 14; a control to adjust an air-fuel mixture into a fuel-rich state; a control to retard an ignition timing of the engine 14; a control to raise a lower limit of the engine speed Ne; a control to limit the output of the engine 14; and a fuel-cut control of the engine 14. The upper limit to which the output of the engine 14 is limited by the GPF plugging engine output limiting portion 90 may be a predetermined fixed value irrespective of the running state of the vehicle 10 such as its running speed V, but may be changed according to the running state of the vehicle 10, the degree of plugging of the GPF filter 46, and/or the specific control of the engine 14 implemented to perform the filter recovering function.

When the GPF 46 has been recovered by the filter recovering function, and the amount of particulate substances accumulated in the GPF filter 46 has been substantially zeroed, for example, the limitation of the output of the engine 14 by the GPF plugging engine output limiting portion 90, and its filter recovering function are terminated. A determination as to whether the amount of particulate substances accumulated in the GPF 46 has been substantially zeroed or not can be made by determining whether the pressure difference ΔP has been reduced to or below a predetermined filter recovery threshold value ΔPr at which the amount of the accumulated particulate substances is substantially zero. Described more specifically, the GPF 46 is considered to have been recovered where ΔP≤ΔPr, namely, when the amount of the accumulated particulate substances has been reduced to substantially zero.

On the other hand, the limitation of the output of the engine causes changes of input torques of the continuously-variable transmission portion 18 and the step-variable transmission portion 20, and deviation of actual values of the input torques from theoretical values expected on the basis of the accelerator pedal operation amount θacc. Accordingly, when the output of the engine 14 is limited, the transmission device 40 and the step-variable transmission portion 20 are shifted from one overall speed position to another or from one AT gear position to another, on the basis of the accelerator pedal operation amount θacc, as indicated in FIG. 6, at their input torque smaller than the value expected on the basis of the accelerator pedal operation amount θacc. Therefore, the limitation of the output of the engine 14 has a risk of generation of a shifting shock of the transmission device 40 or the step-variable transmission portion 20, and a risk of increase of their required shifting time.

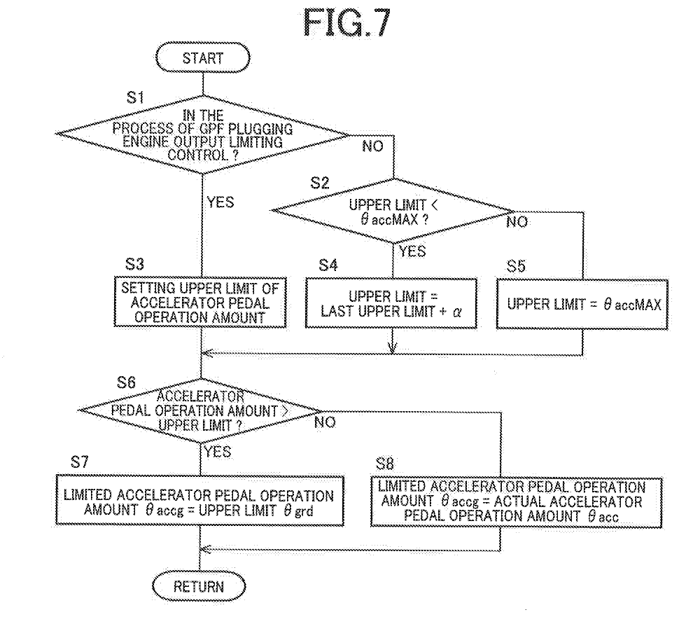

In view of the risk described above, the upper limit setting portion 92 is provided to set an upper limit θgrd of the accelerator pedal operation amount θacc used by the step-variable shifting control portion 82 and the overall speed position shifting control portion 88 to implement their shifting controls, where the output of the engine 14 is limited by the GPF plugging engine output limiting portion 90. The upper limit setting portion 92 sets the upper limit grd θof the accelerator pedal operation amount θacc according to the limitation of the output of the engine 14 by the GPF plugging engine output limiting portion 90. Described more specifically, the upper limit setting portion 92 sets the upper limit θgrd according to an upper limit setting control routine (steps S1-S8) illustrated in the flow chart of FIG. 7.

The upper limit setting control routine of FIG. 7 is initiated with a step S1 to determine whether the GPF plugging engine output limiting portion 90 is in the process of limiting the output of the engine 14. For example, this determination is made on the basis of a flag which is turned on and off depending upon whether the GPF plugging engine output limiting portion 90 is in the process of limiting the output of the engine 14. The control flow goes to a step S2 if a negative determination (NO) is obtained in the step S1, and to a step S3 if an affirmative determination (YES) is obtained in the step S1. The step S3 is implemented to set the upper limit θgrd of the accelerator pedal operation amount θacc used to control the shifting actions of the continuously-variable and step-variable transmission portions 18 and 20. Described more specifically, the output of the drive power source consisting of the engine 14 and the second motor/generator MG2 is limited as a result of the limitation of the output of the engine 14 by the GPF plugging engine output limiting portion 90. The upper limit setting portion 92 sets the upper limit θgrd on the basis of the limitation of the output of the drive power source. In the present drive system 12 provided with the continuously-variable and step-variable transmission portions 18 and 20, the common upper limit θgrd of the accelerator pedal operation amount θacc is set for the shifting controls of the transmission portions 18 and 20. However, different upper values of the upper limit θgrd may be set for the respective transmission portions 18 and 20.

In the transmission device 40, the engine torque Te is transmitted to the continuously-variable transmission portion 18 and to the step-variable transmission portion 20 while the MG2 torque Tm of the second motor/generator MG2 is also transmitted to the step-variable transmission portion 20. The engine torque Te and the MG2 torque Tm are controlled by the hybrid control portion 86 on the basis of the accelerator pedal operation amount θacc. However, only the engine torque Te is limited by the GPF plugging engine output limiting portion 90. Accordingly when the engine torque Te is limited by the GPF plugging engine output limiting portion 90, the upper limit setting portion 92 sets the upper limit θgrd of the accelerator pedal operation amount θacc such that the upper limit θgrd corresponds to a sum of the engine torque Te and the MG2 torque Tm transmitted to the step-variable transmission portion 20. Where the engine output is limited to a predetermined constant upper limit, the upper limit θgrd can be a constant value corresponding to the constant upper limit of the engine output. Where the upper limit of the engine output is changed according to the running state of the vehicle 10, the amount of particulate substances accumulated in the GPF 46, or the manner of control of the engine 14 to recover the GPF filter 46, the upper limit θgrd is changed according to a map or an arithmetic equation and on the basis of the upper limit of the engine torque Te.

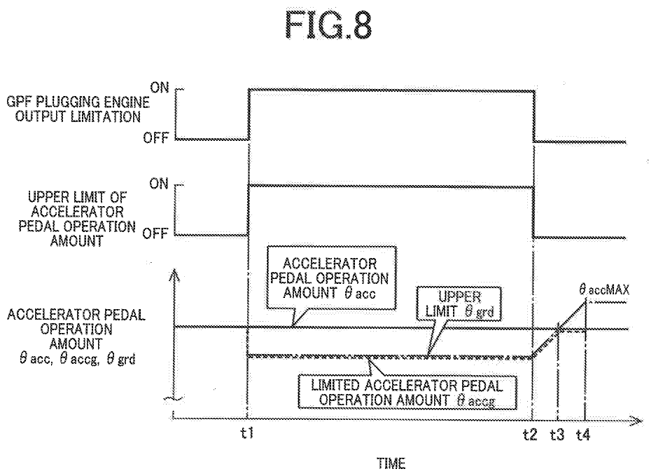

In the step S2 implemented when the negative determination (NO) is made in the step S1, namely, when the GPF plugging engine output limiting portion 90 is not in the process of limiting the output of the engine 14, a determination is made as to whether the upper limit θgrd is smaller than a maximum value θaccMAX of the accelerator pedal operation amount θacc. When an affirmative determination (YES) is obtained in the step S2, that is, when θgrd<θaccMAX, the control flow goes to a step S4 to add a value α to the upper limit θgrd. That is, the upper limit θgrd is incremented by a predetermined amount θ each time the step S4 is implemented. FIG. 8 is the time chart illustrating an example of a change of the upper limit θgrd which is set according to the upper limit setting control routine of the flow chart of FIG. 7, when the output of the engine 14 is limited by the GPF plugging engine output limiting portion 90. The upper limit θgrd, which is indicated by a one-dot chain line in the time chart, is linearly increased after a point of time t2 at which the limitation of the engine output by the GPF plugging engine output limiting portion 90 is terminated. Although the upper limit θgrd is linearly increased in the present embodiment, the upper limit θgrd may be non-linearly increased. When a negative determination (NO) is obtained in the step S2 of the control routine of FIG. 7, that is, when the upper limit θgrd has been increased to the maximum value θaccMAX, namely, where θgrd≥θaccMAX, the control flow goes to a step S5 to set the upper limit θgrd at the maximum value θaccMAX.

After the upper limit θgrd has been set in the steps S3-S5, this upper limit θgrd is used to set a limited value θaccg of the accelerator pedal operation amount θacc in the following steps S6-S8. The step S6 is implemented to determine whether the actual value of the accelerator pedal operation amount θacc is larger than the upper limit θgrd. When an affirmative determination (YES) is obtained in the step S6, that is, when θacc>θgrd, the control flow goes to the step S7 to set the upper limit θgrd as the limited value θaccg of the accelerator pedal operation amount θacc. When a negative determination (NO) is obtained in the step S6, that is, when θace≤θgrd, the control flow goes to the step S8 to set the actual value of the accelerator pedal operation amount θacc as the limited value θaccg. The limited value θaccg is used in place of the actual value θacc by the step-variable shifting control portion 82 and the overall speed position shifting control portion 88 to determine shifting actions of the respective step-variable transmission portion 20 and transmission device 40, in the process of the engine output control implemented by the GPF plugging engine output limiting portion 90.

In the time chart of FIG. 8, “t1” represents a point of time at which the limitation of the engine output is initiated by the GPF plugging engine output limiting portion 90, that is, at which the affirmative determination (YES) is obtained in the step S1, and the upper limit θgrd of the accelerator pedal operation amount θcc is set. As a result, the step-variable shifting control portion 82 and the overall speed position shifting control portion 88 control the shifting actions of the respective step-variable transmission portion 20 and transmission device 40 from one of the AT gear positions to another and from one of overall speed positions to another, on the basis of the limited value θaccg of the accelerator pedal operation amount θacc indicated by a broken line, in place of the actual value θacc indicated by a solid line. The one-dot chain line in FIG. 8 indicates an example of the upper limit θgrd to or below which the actual accelerator pedal operation amount θacc is limited in the determination of the shifting action between the two AT gear positions or two overall speed positions. In the specific example of FIG. 8, the accelerator pedal operation amount θacc is abruptly reduced from the actual value to the limited value θaccg equal to the upper limit θgrd, at the point of time t1. However, the accelerator pedal operation amount θacc may be gradually reduced from the actual value to the limited value θaccg (upper limit accelerator pedal operation amount θacc is abruptly reduced from the actual value to the limited value θaccg). At the point of time t2 indicated in FIG. 8, the limitation of the engine output by the GPF plugging engine output limiting portion 90 is terminated. During a time period between the points of time t1 and t2, the upper limit θgrd smaller than the actual accelerator pedal operation amount θacc is kept used as the limited value θaccg. In the example of FIG. 8 in which the amount of limitation of the output of the engine 14 by the GPF plugging engine output limiting portion 90 is held constant during the above-indicated time period t1-t2, the upper limit θgrd is held constant during this time period.

After the limitation of the output of the engine 14 by the GPF plugging engine output limiting portion 90 is terminated at the point of time t2, the upper limit θgrd is increased at a predetermined constant rate so that the limited value θaccg of the accelerator pedal operation amount θacc is accordingly increased. After the upper limit θgrd has exceeded the actual value θacc at a point of time t3, the actual value θacc is limited to the limited value θaccg, so that the shifting actions of the transmission device 40 and the step-variable transmission portion 20 are substantially controlled on the basis of the actual value θacc. After the upper limit θgrd has exceeded the maximum value θaccMAX at a point of time t4, the control of the shifting actions on the basis of the limited value θaccg is terminated, and the normal step-variable and overall speed position shifting controls on the basis of the actual value θacc are resumed.

The electronic control device 80 provided in the present embodiment for controlling the vehicle 10 is configured to set the upper limit θgrd of the accelerator pedal operation amount θacc used by the step-variable shifting control portion 82 to shift the step-variable transmission portion 20 from one AT gear position to another, and by the overall speed position shifting control portion 88 to shift the transmission device 40 from one overall speed position to another, while the output of the engine 14 is limited by the GPF plugging engine output limiting portion 90 as a result of plugging of the GPF filter 46. The shifting controls of the step-variable transmission portion 20 and the transmission device 40 are implemented on the basis of the limited value θaccg of the accelerator pedal operation amount θacc, which is determined by the upper limit θgrd. Accordingly, the present electronic control device 80 prevents erroneous shifting controls of the step-variable transmission portion 20 and the transmission device 40 due to the use of the actual value θacc of the accelerator pedal operation amount θacc, which would erroneous shifting controls take place in the absence of the upper limit θgrd to be set by the upper limit setting portion 92. Thus, the present electronic control device 80 permits reduction of a shifting shock of the transmission device 40 and its required shifting time, ensuring adequate shifting performance of the transmission device 40.

Further, the present embodiment is further configured such that the upper limit θgrd of the accelerator pedal operation amount θacc is incremented by the predetermined amount α after the limitation of the output of the engine 14 by the GPF plugging engine output limiting portion 90 is terminated, so that the step-variable transmission portion 20 or the transmission device 40 is adequately shifted according to an increase of the output of the engine 14 after termination of the limitation of the engine output.

In addition, the present embodiment is configured such that the GPF plugging engine output limiting portion 90 has the filter recovering function for automatically recovering the GPF 46, so that the GPF plugging engine output limiting portion 90 limits the output of the engine 14 by performing the filter recovering function, or by implementing the control for limiting the output of the engine 14 in addition to performing the filter recovering function. Accordingly, the present embodiment permits efficient elimination of plugging of the GPF 46 to minimize a need of limiting the output of the engine 14, while at the same time preventing erroneous shifting controls of the step-variable transmission portion 20 and the transmission device 40 due to the limitation of the output of the engine 14 during limitation of the upper limit θgrd of the accelerator pedal operation amount θacc.

Further, the vehicle 10 to be controlled by the electronic control device 80 is the hybrid vehicle wherein the transmission device 40 includes the electrically controlled continuously-variable transmission portion 18 and the mechanically operated step-variable transmission portion 20, and the vehicle driving electric motor in the form of the second motor/generator MG2 is connected to the intermediate power transmitting member 30 disposed between the continuously-variable transmission portion 18 and the step-variable transmission portion 20. The electronic control device 80 for this hybrid vehicle 10 is configured such that the overall speed position shifting control portion 88 implements the shifting control of the continuously-variable transmission portion 18 concurrently with the shifting control of the step-variable transmission portion 20 by the step-variable shifting control portion 82, to shift the transmission device 40 to the selected one of the overall speed positions. Further, the upper limit setting portion 92 is configured to set the upper limit θgrd of the accelerator pedal operation amount θacc, which is used commonly by both of the step-variable shifting control portion 82 and the overall speed position shifting control portion 88, on the basis of the output of the drive power source as a whole including the second motor/generator MG2, which output is limited as a result of the limitation of the output of the engine 14 by the GPF plugging engine output limiting portion 90. Accordingly, concurrent or cooperative shifting controls of the step-variable transmission portion 20 and the continuously-variable transmission portion 18 by the respective step-variable shifting control portion 82 and overall speed position shifting control portion 88 can be adequately implemented to shift the transmission device 40 to the selected one of the overall speed positions. In this respect, it is noted that the step-variable transmission portion 20 which receives output torques of both of the engine 14 and the second motor/generator MG2 is relatively likely to suffer from a shifting shock. However, the upper limit θgrd of the accelerator pedal operation amount θacc is set on the basis of the output limitation of the drive power source as a whole, so that a risk of generation of the shifting shock of the step-variable transmission portion 20 can be effectively reduced.

While the preferred embodiment of this invention has been described in detail by reference to the drawings, it is to be understood that the present invention may be otherwise embodied.

In the illustrated embodiment, the ten overall speed positions are selectively established for the four AT gear positions. However, the numbers of the overall speed positions and the AT gear positions are not limited to those of the illustrated embodiment. The number of the overall speed positions is preferably equal to or larger than that of the AT gear positions, more preferably larger than that of the AT gear positions. For example, the number of the overall speed positions is desirably twice the number of the AT gear positions, or more. The step-variable transmission portion 20 is shifted from one of the AT gear positions to another, so that the rotating speed of the intermediate power transmitting member 30 and the operating speed of the second motor/generator MG2 connected to the intermediate power transmitting member 30 are held within predetermined ranges. On the other hand, the transmission device 40 is shifted from one of the overall speed positions to another, so that the engine speed Ne is held within a predetermined range. In view of the above, the numbers of the AT gear positions and the overall speed positions are suitably determined. The present invention is equally applicable to a control apparatus for a hybrid vehicle, which is not provided with the overall speed position shifting control portion 88 for controlling the continuously-variable transmission portion 18 so as to selectively establish the overall speed positions, and to a control apparatus for an engine-drive vehicle not provided with the continuously-variable transmission portion 18.

It is to be further understood that the present invention may be embodied with various other changes and modifications not described herein, which may occur to those skilled in the art.

### NOMENCLATURE OF ELEMENTS

10: vehicle (hybrid vehicle)
14: engine
18: electrically controlled continuously-variable transmission portion
20: mechanically operated step-variable transmission portion
28: drive wheels
30: intermediate power transmitting member
40: transmission device (automatic transmission)
46: GPF (filter)
80: electronic control device (control apparatus)
82: step-variable shifting control portion (shift control portion)
86: hybrid control portion (drive power source control portion)
88: overall speed position shifting control portion (shift control portion)
90: GPF plugging engine output limiting portion (engine output control portion)
92: upper limit setting portion
MG1: first motor/generator (differential motor/generator)
MG2: second motor/generator (vehicle driving electric motor)
C1, C2: clutches (frictional coupling devices)
B1, B2: brakes (frictional coupling devices)
No: output speed (vehicle running speed)
θacc: accelerator pedal operation amount (operator-required vehicle drive force)
θaccg: limited accelerator pedal operation amount (operator-required vehicle drive force)
θgrd: upper limit

What is claimed is:

1. A control apparatus for a vehicle provided with an engine having a filter for removing particulate substances from an exhaust emission, drive wheels, and an automatic transmission constituting a part of a power transmitting path between the engine and the drive wheels, the control apparatus comprising:
a shift control portion configured to control a speed ratio of the automatic transmission on the basis of an operator-required vehicle drive force and a running speed of the vehicle;
a drive power source control portion configured to control an output of the engine on the basis of the operator-required vehicle drive force;
an engine output limiting portion configured to limit the output of the engine, preferentially to the output control of the engine by the drive power source control portion, while the filter is plugged with the particulate substances accumulated therein; and
an upper limit setting portion configured to set an upper limit of the operator-required vehicle drive force used by the shift control portion, on the basis of limitation of the output of the engine by the engine output limiting portion, while the output of the engine is limited by the engine output limiting portion.

2. The control apparatus according to claim 1, wherein the upper limit setting portion gradually increases the upper limit after the limitation of the output of the engine by the engine output limiting portion is terminated.

3. The control apparatus according to claim 1, wherein the operator-required vehicle drive force is an operation amount of an accelerator pedal.

4. The control apparatus according to claim 2, wherein the operator-required vehicle drive force is an operation amount of an accelerator pedal.

5. The control apparatus according to claim 1, wherein the engine output limiting portion has a filter recovering function for automatically recovering the filter by controlling the engine so as to facilitate burning of the particulate substances accumulated in the filter, during running of the vehicle, the engine output limiting portion limiting the output of the engine by performing the filter recovering function, or by implementing a control for limiting the output of the engine in addition to performing the filter recovering function.

6. The control apparatus according to claim 2, wherein the engine output limiting portion has a filter recovering function for automatically recovering the filter by controlling the engine so as to facilitate burning of the particulate substances accumulated in the filter, during running of the vehicle, the engine output limiting portion limiting the output of the engine by performing the filter recovering function, or by implementing a control for limiting the output of the engine in addition to performing the filter recovering function.

7. The control apparatus according to claim 3, wherein the engine output limiting portion has a filter recovering function for automatically recovering the filter by controlling the engine so as to facilitate burning of the particulate substances accumulated in the filter, during running of the vehicle, the engine output limiting portion limiting the output of the engine by performing the filter recovering function, or by implementing a control for limiting the output of the engine in addition to performing the filter recovering function.

8. The control apparatus according to claim 4, wherein the engine output limiting portion has a filter recovering function for automatically recovering the filter by controlling the engine so as to facilitate burning of the particulate substances accumulated in the filter, during running of the vehicle, the engine output limiting portion limiting the output of the engine by performing the filter recovering function, or by implementing a control for limiting the output of the engine in addition to performing the filter recovering function.

9. The control apparatus according to claim 1, wherein the automatic transmission is a transmission device including an electrically controlled continuously-variable transmission portion connected to the engine, a differential motor/generator and an intermediate power transmitting member, and a mechanically operated step-variable transmission portion disposed between the intermediate power transmitting member and the drive wheels, a rotary motion of the engine being transmitted through the continuously-variable transmission portion to the intermediate power transmitting member such that an operating speed of the engine is continuously changed with a torque control of the differential motor/generator, the step-variable transmission portion having a plurality of frictional coupling devices which are selectively engaged and released to mechanically establish a selected one of a plurality of AT gear positions having respective different values of a ratio of a rotating speed of the intermediate power transmitting member to an output speed of the step-variable transmission portion,
the shift control portion including a step-variable shifting control portion configured to shift the step-variable transmission portion to the selected AT gear position on the basis of the operator-required vehicle drive force and the running speed of the vehicle, and an overall speed position shifting control portion configured to control the continuously-variable transmission portion on the basis of the operator-required vehicle drive force and the running speed of the vehicle, for selectively establishing a plurality of overall speed positions of the transmission device which have respective different values of a ratio of the operating speed of the engine to the output speed of the step-variable transmission portion,
at least one of the plurality of overall speed positions being available for each of the plurality of AT gear positions, the overall speed position shifting control portion implementing a shifting control of the continuously-variable transmission portion concurrently with a shifting control of the step-variable transmission portion by the step-variable shifting control portion, to shift the transmission device to a selected one of the overall speed positions,
the vehicle being provided with a vehicle driving electric motor which cooperates with the engine to function as a drive power source and which is operatively connected to the intermediate power transmitting member in a power transmittable manner,
the drive power source control portion controlling both of the engine and the vehicle driving electric motor on the basis of the operator-required vehicle drive force,
the upper limit setting portion setting the upper limit of the operator-required vehicle drive force used commonly by both of the step-variable shifting control portion and the overall speed position shifting control portion, on the basis of an output of the drive power source as a whole including the vehicle driving electric motor, which output is limited as a result of the limitation of the output of the engine by the engine output limiting portion.

10. The control apparatus according to claim 2, wherein the automatic transmission is a transmission device including an electrically controlled continuously-variable transmission portion connected to the engine, a differential motor/generator and an intermediate power transmitting member, and a mechanically operated step-variable transmission portion disposed between the intermediate power transmitting member and the drive wheels, a rotary motion of the engine being transmitted through the continuously-variable transmission portion to the intermediate power transmitting member such that an operating speed of the engine is continuously changed with a torque control of the differential motor/generator, the step-variable transmission portion having a plurality of frictional coupling devices which are selectively engaged and released to mechanically establish a selected one of a plurality of AT gear positions having respective different values of a ratio of a rotating speed of the intermediate power transmitting member to an output speed of the step-variable transmission portion,
the shift control portion including a step-variable shifting control portion configured to shift the step-variable transmission portion to the selected AT gear position on the basis of the operator-required vehicle drive force and the running speed of the vehicle, and an overall speed position shifting control portion configured to control the continuously-variable transmission portion on the basis of the operator-required vehicle drive force and the running speed of the vehicle, for selectively establishing a plurality of overall speed positions of the transmission device which have respective different values of a ratio of the operating speed of the engine to the output speed of the step-variable transmission portion,
at least one of the plurality of overall speed positions being available for each of the plurality of AT gear positions, the overall speed position shifting control portion implementing a shifting control of the continuously-variable transmission portion concurrently with a shifting control of the step-variable transmission portion by the step-variable shifting control portion, to shift the transmission device to a selected one of the overall speed positions,
the vehicle being provided with a vehicle driving electric motor which cooperates with the engine to function as a drive power source and which is operatively connected to the intermediate power transmitting member in a power transmittable manner,
the drive power source control portion controlling both of the engine and the vehicle driving electric motor on the basis of the operator-required vehicle drive force,
the upper limit setting portion setting the upper limit of the operator-required vehicle drive force used commonly by both of the step-variable shifting control portion and the overall speed position shifting control portion, on the basis of an output of the drive power source as a whole including the vehicle driving electric motor, which output is limited as a result of the limitation of the output of the engine by the engine output limiting portion.

11. The control apparatus according to claim 3, wherein the automatic transmission is a transmission device including an electrically controlled continuously-variable transmission portion connected to the engine, a differential motor/generator and an intermediate power transmitting member, and a mechanically operated step-variable transmission portion disposed between the intermediate power transmitting member and the drive wheels, a rotary motion of the engine being transmitted through the continuously-variable transmission portion to the intermediate power transmitting member such that an operating speed of the engine is continuously changed with a torque control of the differential motor/generator, the step-variable transmission portion having a plurality of frictional coupling devices which are selectively engaged and released to mechanically establish a selected one of a plurality of AT gear positions having respective different values of a ratio of a rotating speed of the intermediate power transmitting member to an output speed of the step-variable transmission portion,
the shift control portion including a step-variable shifting control portion configured to shift the step-variable transmission portion to the selected AT gear position on the basis of the operator-required vehicle drive force and the running speed of the vehicle, and an overall speed position shifting control portion configured to control the continuously-variable transmission portion on the basis of the operator-required vehicle drive force and the running speed of the vehicle, for selectively establishing a plurality of overall speed positions of the transmission device which have respective different values of a ratio of the operating speed of the engine to the output speed of the step-variable transmission portion,
at least one of the plurality of overall speed positions being available for each of the plurality of AT gear positions, the overall speed position shifting control portion implementing a shifting control of the continuously-variable transmission portion concurrently with a shifting control of the step-variable transmission portion by the step-variable shifting control portion, to shift the transmission device to a selected one of the overall speed positions,
the vehicle being provided with a vehicle driving electric motor which cooperates with the engine to function as a drive power source and which is operatively connected to the intermediate power transmitting member in a power transmittable manner,
the drive power source control portion controlling both of the engine and the vehicle driving electric motor on the basis of the operator-required vehicle drive force,
the upper limit setting portion setting the upper limit of the operator-required vehicle drive force used commonly by both of the step-variable shifting control portion and the overall speed position shifting control portion, on the basis of an output of the drive power source as a whole including the vehicle driving electric motor, which output is limited as a result of the limitation of the output of the engine by the engine output limiting portion.

12. The control apparatus according to claim 4, wherein the automatic transmission is a transmission device including an electrically controlled continuously-variable transmission portion connected to the engine, a differential motor/generator and an intermediate power transmitting member, and a mechanically operated step-variable transmission portion disposed between the intermediate power transmitting member and the drive wheels, a rotary motion of the engine being transmitted through the continuously-variable transmission portion to the intermediate power transmitting member such that an operating speed of the engine is continuously changed with a torque control of the differential motor/generator, the step-variable transmission portion having a plurality of frictional coupling devices which are selectively engaged and released to mechanically establish a selected one of a plurality of AT gear positions having respective different values of a ratio of a rotating speed of the intermediate power transmitting member to an output speed of the step-variable transmission portion,
the shift control portion including a step-variable shifting control portion configured to shift the step-variable transmission portion to the selected AT gear position on the basis of the operator-required vehicle drive force and the running speed of the vehicle, and an overall speed position shifting control portion configured to control the continuously-variable transmission portion on the basis of the operator-required vehicle drive force and the running speed of the vehicle, for selectively establishing a plurality of overall speed positions of the transmission device which have respective different values of a ratio of the operating speed of the engine to the output speed of the step-variable transmission portion,
at least one of the plurality of overall speed positions being available for each of the plurality of AT gear positions, the overall speed position shifting control portion implementing a shifting control of the continuously-variable transmission portion concurrently with a shifting control of the step-variable transmission portion by the step-variable shifting control portion, to shift the transmission device to a selected one of the overall speed positions,
the vehicle being provided with a vehicle driving electric motor which cooperates with the engine to function as a drive power source and which is operatively connected to the intermediate power transmitting member in a power transmittable manner,
the drive power source control portion controlling both of the engine and the vehicle driving electric motor on the basis of the operator-required vehicle drive force,
the upper limit setting portion setting the upper limit of the operator-required vehicle drive force used commonly by both of the step-variable shifting control portion and the overall speed position shifting control portion, on the basis of an output of the drive power source as a whole including the vehicle driving electric motor, which output is limited as a result of the limitation of the output of the engine by the engine output limiting portion.

13. The control apparatus according to claim 5, wherein the automatic transmission is a transmission device including an electrically controlled continuously-variable transmission portion connected to the engine, a differential motor/generator and an intermediate power transmitting member, and a mechanically operated step-variable transmission portion disposed between the intermediate power transmitting member and the drive wheels, a rotary motion of the engine being transmitted through the continuously-variable transmission portion to the intermediate power transmitting member such that an operating speed of the engine is continuously changed with a torque control of the differential motor/generator, the step-variable transmission portion having a plurality of frictional coupling devices which are selectively engaged and released to mechanically establish a selected one of a plurality of AT gear positions having respective different values of a ratio of a rotating speed of the intermediate power transmitting member to an output speed of the step-variable transmission portion,
the shift control portion including a step-variable shifting control portion configured to shift the step-variable transmission portion to the selected AT gear position on the basis of the operator-required vehicle drive force and the running speed of the vehicle, and an overall speed position shifting control portion configured to control the continuously-variable transmission portion on the basis of the operator-required vehicle drive force and the running speed of the vehicle, for selectively establishing a plurality of overall speed positions of the transmission device which have respective different values of a ratio of the operating speed of the engine to the output speed of the step-variable transmission portion,
at least one of the plurality of overall speed positions being available for each of the plurality of AT gear positions, the overall speed position shifting control portion implementing a shifting control of the continuously-variable transmission portion concurrently with a shifting control of the step-variable transmission portion by the step-variable shifting control portion, to shift the transmission device to a selected one of the overall speed positions,
the vehicle being provided with a vehicle driving electric motor which cooperates with the engine to function as a drive power source and which is operatively connected to the intermediate power transmitting member in a power transmittable manner,
the drive power source control portion controlling both of the engine and the vehicle driving electric motor on the basis of the operator-required vehicle drive force,
the upper limit setting portion setting the upper limit of the operator-required vehicle drive force used commonly by both of the step-variable shifting control portion and the overall speed position shifting control portion, on the basis of an output of the drive power source as a whole including the vehicle driving electric motor, which output is limited as a result of the limitation of the output of the engine by the engine output limiting portion.

14. The control apparatus according to claim 6, wherein the automatic transmission is a transmission device including an electrically controlled continuously-variable transmission portion connected to the engine, a differential motor/generator and an intermediate power transmitting member, and a mechanically operated step-variable transmission portion disposed between the intermediate power transmitting member and the drive wheels, a rotary motion of the engine being transmitted through the continuously-variable transmission portion to the intermediate power transmitting member such that an operating speed of the engine is continuously changed with a torque control of the differential motor/generator, the step-variable transmission portion having a plurality of frictional coupling devices which are selectively engaged and released to mechanically establish a selected one of a plurality of AT gear positions having respective different values of a ratio of a rotating speed of the intermediate power transmitting member to an output speed of the step-variable transmission portion,
the shift control portion including a step-variable shifting control portion configured to shift the step-variable transmission portion to the selected AT gear position on the basis of the operator-required vehicle drive force and the running speed of the vehicle, and an overall speed position shifting control portion configured to control the continuously-variable transmission portion on the basis of the operator-required vehicle drive force and the running speed of the vehicle, for selectively establishing a plurality of overall speed positions of the transmission device which have respective different values of a ratio of the operating speed of the engine to the output speed of the step-variable transmission portion,
at least one of the plurality of overall speed positions being available for each of the plurality of AT gear positions, the overall speed position shifting control portion implementing a shifting control of the continuously-variable transmission portion concurrently with a shifting control of the step-variable transmission portion by the step-variable shifting control portion, to shift the transmission device to a selected one of the overall speed positions,
the vehicle being provided with a vehicle driving electric motor which cooperates with the engine to function as a drive power source and which is operatively connected to the intermediate power transmitting member in a power transmittable manner,
the drive power source control portion controlling both of the engine and the vehicle driving electric motor on the basis of the operator-required vehicle drive force,
the upper limit setting portion setting the upper limit of the operator-required vehicle drive force used commonly by both of the step-variable shifting control portion and the overall speed position shifting control portion, on the basis of an output of the drive power source as a whole including the vehicle driving electric motor, which output is limited as a result of the limitation of the output of the engine by the engine output limiting portion.

15. The control apparatus according to claim 7, wherein the automatic transmission is a transmission device including an electrically controlled continuously-variable transmission portion connected to the engine, a differential motor/generator and an intermediate power transmitting member, and a mechanically operated step-variable transmission portion disposed between the intermediate power transmitting member and the drive wheels, a rotary motion of the engine being transmitted through the continuously-variable transmission portion to the intermediate power transmitting member such that an operating speed of the engine is continuously changed with a torque control of the differential motor/generator, the step-variable transmission portion having a plurality of frictional coupling devices which are selectively engaged and released to mechanically establish a selected one of a plurality of AT gear positions having respective different values of a ratio of a rotating speed of the intermediate power transmitting member to an output speed of the step-variable transmission portion,
the shift control portion including a step-variable shifting control portion configured to shift the step-variable transmission portion to the selected AT gear position on the basis of the operator-required vehicle drive force and the running speed of the vehicle, and an overall speed position shifting control portion configured to control the continuously-variable transmission portion on the basis of the operator-required vehicle drive force and the running speed of the vehicle, for selectively establishing a plurality of overall speed positions of the transmission device which have respective different values of a ratio of the operating speed of the engine to the output speed of the step-variable transmission portion,
at least one of the plurality of overall speed positions being available for each of the plurality of AT gear positions, the overall speed position shifting control portion implementing a shifting control of the continuously-variable transmission portion concurrently with a shifting control of the step-variable transmission portion by the step-variable shifting control portion, to shift the transmission device to a selected one of the overall speed positions,
the vehicle being provided with a vehicle driving electric motor which cooperates with the engine to function as a drive power source and which is operatively connected to the intermediate power transmitting member in a power transmittable manner,
the drive power source control portion controlling both of the engine and the vehicle driving electric motor on the basis of the operator-required vehicle drive force,
the upper limit setting portion setting the upper limit of the operator-required vehicle drive force used commonly by both of the step-variable shifting control portion and the overall speed position shifting control portion, on the basis of an output of the drive power source as a whole including the vehicle driving electric motor, which output is limited as a result of the limitation of the output of the engine by the engine output limiting portion.

16. The control apparatus according to claim 8, wherein the automatic transmission is a transmission device including an electrically controlled continuously-variable transmission portion connected to the engine, a differential motor/generator and an intermediate power transmitting member, and a mechanically operated step-variable transmission portion disposed between the intermediate power transmitting member and the drive wheels, a rotary motion of the engine being transmitted through the continuously-variable transmission portion to the intermediate power transmitting member such that an operating speed of the engine is continuously changed with a torque control of the differential motor/generator, the step-variable transmission portion having a plurality of frictional coupling devices which are selectively engaged and released to mechanically establish a selected one of a plurality of AT gear positions having respective different values of a ratio of a rotating speed of the intermediate power transmitting member to an output speed of the step-variable transmission portion,
the shift control portion including a step-variable shifting control portion configured to shift the step-variable transmission portion to the selected AT gear position on the basis of the operator-required vehicle drive force and the running speed of the vehicle, and an overall speed position shifting control portion configured to control the continuously-variable transmission portion on the basis of the operator-required vehicle drive force and the running speed of the vehicle, for selectively establishing a plurality of overall speed positions of the transmission device which have respective different values of a ratio of the operating speed of the engine to the output speed of the step-variable transmission portion,
at least one of the plurality of overall speed positions being available for each of the plurality of AT gear positions, the overall speed position shifting control portion implementing a shifting control of the continuously-variable transmission portion concurrently with a shifting control of the step-variable transmission portion by the step-variable shifting control portion, to shift the transmission device to a selected one of the overall speed positions,
the vehicle being provided with a vehicle driving electric motor which cooperates with the engine to function as a drive power source and which is operatively connected to the intermediate power transmitting member in a power transmittable manner,
the drive power source control portion controlling both of the engine and the vehicle driving electric motor on the basis of the operator-required vehicle drive force,
the upper limit setting portion setting the upper limit of the operator-required vehicle drive force used commonly by both of the step-variable shifting control portion and the overall speed position shifting control portion, on the basis of an output of the drive power source as a whole including the vehicle driving electric motor, which output is limited as a result of the limitation of the output of the engine by the engine output portion.
